(19) United States
(12) Patent Application Publication
(10) Pub. No.: US 2013/0161060 A1
(43) Pub. Date: Jun. 27, 2013

(54) FLAME AND DRIP RESISTANT HALOGEN-FREE INSULATING COMPOSITION

(71) Applicant: Viakable, S. A. de C. V., San Nicolas de los Garza (MX)

(72) Inventors: VICTOR HUGO PONCE IBARRA, SAN NICOLAS DE LOS GARZA (MX); SERGIO ARTURO MONTES VALDEZ, MONTERREY (MX)

(73) Assignee: VIAKABLE, S. A. DE C. V., SAN NICOLAS DE LOS GARZA (MX)

(21) Appl. No.: 13/715,508

(22) Filed: Dec. 14, 2012

(30) Foreign Application Priority Data
Dec. 16, 2011 (MX) MX/A/2011/013924

(51) Int. Cl. C08L 23/06; H01B 7/00; C08L 51/00

(52) U.S. Cl. CPC C08L 23/06; C08L 51/003; H01B 7/00
USPC 174/110 PM; 524/405

(57) ABSTRACT

A flame and drip resistant halogen-free insulating composition which is extrudible and suitable for a insulating coating or a sheath of electrical conductors, which has a mixture of low density polyethylene, at least one polyolefin grafted with maleic anhydride, at least one flame retardant, and at least one filler, and have a burning time of less than 8 minutes after the exposure to a flame for 40 minutes with a damage extent of less than 70 centimeters.

### TECHNICAL FIELD OF THE INVENTION

This invention relates to the field of insulation compositions for electric or data communication cable sheaths and more precisely, to a halogen-free composition that is resistant to oil and to dripping, which is extrudible and suitable for the coating of insulating or the covering of electrical conductors.

### BACKGROUND OF THE INVENTION

Insulated electrical cables and/or coated with halogen-free materials are high performance products, as they offer the appropriate balance of high operating temperature properties, fire resistance, water resistance, abrasion resistance, acceptable electrical properties and flame resistance. When these wires burn, they emit very small amounts of smoke, which, as they are not halogenated, are non-corrosive. However, under certain circumstances it is required that the electrical cables, for example marine cables, have an outer cover that is not only flame resistant but also has a dripping resistance, i.e., in case of fire it shouldn't easily burn, and neither melt, because if it melts, it could expose the electrical conductor. Therefore, certain types of cable are subject to flammability tests such as the IEC 60092 test, under which the IEC 60032-3-22 flame test is carried out, comprising the drip resistance test.

The flame test IEC 60032-3-22 consists of measuring and cutting various lengths of cable, which are mounted on a tray, the number of such sections depends on a certain formula included in the standard, which specifies that there must be seven liters of non-metallic material per meter of the test tray. Said tray is a reproduction of the attachments that are commonly used to place the cables in buildings and industrial constructions. The application of the flame has a duration of forty minutes, it is propane fed, so that we know the amount of energy applied. Once this time is over, it is observed how much more time the cable remains on fire, up to a maximum of one hour. After that, the length of the damaged/burnt cable is measured. The requirement for the cable to pass the test, is that the extent of the damage is not more than 2.5 meters, or that the burning time after application of the flame is less than 60 minutes. This flame test has a slight resemblance to the FT4 test of UL44, which is less strict for the cable being tested.

Some examples of electric cables of the prior art with insulating sheaths of which the composition complies with the requirements of IEC 60032-3-22 are disclosed in patent documents U.S. Pat. No. 7,737,364B2, CN-2669325Y, CN-201259795 and CN-201465587.

### SUMMARY OF THE INVENTION

In view of the above and with the aim of finding solutions to the limitations encountered, it is an object of the invention to provide a flame and drip resistant halogen-free insulating composition, having from 35% to 65% by weight of low density polyethylene, from 0.1% to 15% by weight of at least one polyolefin grafted with maleic anhydride, from 5% to 45% by weight of at least one flame retardant, and from 10% to 60% by weight of at least one filler, and which has a burning time of less than 8 minutes after the exposure to a flame for 40 minutes, and a damage extension of less than 70 centimeters.

Another object of the present invention is to offer the use of a flame and drip resistant halogen-free insulating composition for an electric cable sheath, having from 35% to 65% by weight of low density polyethylene, from 0.1% to 15% by weight of at least one polyolefin grafted with maleic anhydride, from 5% to 45% by weight of at least one flame retardant, and from 10% to 60% by weight of at least one filler, and which has a burning time of less than 8 minutes after the exposure to a flame for 40 minutes, and a damage extension of less than 70 centimeters on the insulation sheath of an electrical cable.

Another object of the present invention is to provide an electric cable having at least one electrical conductor, and at least one flame and drip resistant halogen-free insulating sheath covering the electrical conductor, the flame and drip resistant halogen-free insulating sheath includes from 35% to 65% by weight of low density polyethylene, from 0.1% to 15% by weight of at least one polyolefin grafted with maleic anhydride, from 5% to 45% by weight of at least one flame retardant, and from 10% to 60% by weight of at least one filler, and which has a burning time of less than 8 minutes after the exposure to a flame for 40 minutes, and a damage extension of less than 70 centimeters on the insulation sheath of an electrical cable.

### BRIEF DESCRIPTION OF THE FIGURES

The characteristic details of the invention are described in the following paragraphs in conjunction with the accompanying figures, which are for the purpose of defining the invention but without limiting its scope.

FIG. 1 shows a sectional perspective view of a cable with a flame and drip resistant halogen-free insulating sheath, according to the invention.

### DETAILED DESCRIPTION OF THE INVENTION

The characteristic details of the invention are described in the following paragraphs, which are for the purpose of defining the invention but without limiting its scope.

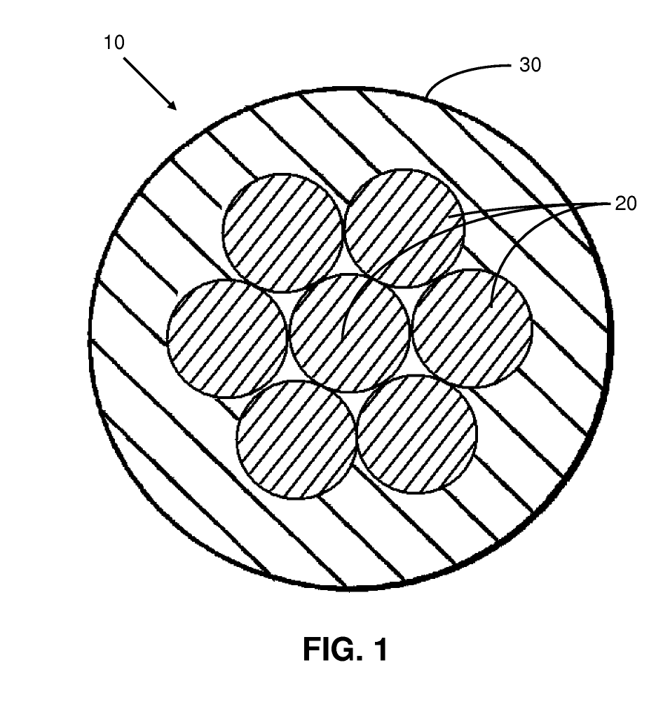

In FIG. 1, a cable 10 is illustrated comprising one or more conductors 20 and one or more insulating sheaths 30, wherein at least one of the insulation sheaths 30 comprises a flame and drip resistant halogen-free insulating composition, according to the invention.

The flame and drip resistant halogen-free insulating composition, according to the invention shows compounds that in turn could consist of multiple components.

The compounds are described individually below, without necessarily being described in an order of importance.

### Compound I: Low Density Polyethylene

The flame and drip resistant halogen-free insulating composition of the present invention contains one or more low density polyethylenes.

The linear low density polyethylene may have a density in the range from about 0.89 g/cm³ to about 0.95 g/cm³, and is preferably in the approximate range of 0.910 g/cm³ to 0.940 g/cm³. The low density polyethylene used is homopolymer composed of a single monomeric unit or monomer unit. The fluidity index can be in the approximate range of 0.1 g/min to 25 g/min, and is preferably in the approximate range of 1 g/min to 10 g/min.

In this case the main function of the low density polyethylene is as an insulator, i.e., it is selected for its electrical properties.

The flame and drip resistant halogen-free insulating composition of the invention has a content of low density polyethylene of about 35% to about 65% by weight of the total composition, and in a more particular embodiment, the low density polyethylene content is about 45% to about 55% by weight.

### Compound II: Compatibilizer (Polyolefin Grafted With Maleic Anhydride)

The flame and drip resistant halogen-free insulating composition of the present invention, contains at least one compatibilizer, in particular at least one polyolefin grafted with maleic anhydride is preferred.

Examples of polyolefins grafted with maleic anhydride useful in the flame and drip resistant halogen-free insulating composition of the present invention are: low density polyethylene grafted with maleic anhydride, linear low density polyethylene grafted with maleic anhydride, polypropylene grafted with maleic anhydride, high density polyethylene grafted with maleic anhydride, ethylene copolymer grafted with maleic anhydride, and combinations thereof. The preferred polyolefin grafted with maleic anhydride is linear low density polyethylene grafted with maleic anhydride.

The graft of maleic anhydride under the attack of the flame enhances the performance of the compound in its property of flame resistance.

The flame and drip resistant halogen-free insulating composition of the invention has a content of polyolefin grafted with maleic anhydride of about 0.1% to about 15% by weight of the total composition, and in a more particular embodiment, the content of polyolefin grafted with maleic anhydride is about 1% to about 7% by weight.

### Compound III: Flame Retardants

The flame and drip resistant halogen-free insulating composition of the present invention contains at least one flame retardant, whether synthetic or mineral by origin, and at the same time the latter is used as a filler in the present composition, so that it can function as a flame retardant and/or reducing cost for the final composition.

A wide variety of flame retardants, synthetic or mineral by origin may be useful in the flame and oil resistant halogen-free composition of the present invention. Examples of flame retardants of synthetic origin are: synthetic alumina trihydrate, treated alumina trihydrate, synthetic magnesium hydroxide, treated magnesium hydroxide, synthetic magnesium-aluminum layered double hydroxide, treated magnesium-aluminum layered double hydroxide, zinc borate, and combinations thereof. Examples of flame retardants of mineral origin are: natural alumina trihydrate, natural magnesium hydroxide, natural magnesium-aluminum layered double hydroxide, and combinations thereof.

In a combination of flame retardants useful for the invention, there may be alumina trihydrate and zinc borate in a ratio of 1:20 to 1:5 by weight.

The flame and drip resistant halogen-free insulating composition of the present invention has a flame retardant content of about 5% to about 45% by weight of the total composition, and in a more particular embodiment, the flame retardant content is about 10% to about 30% by weight.

### Compound IV: Fillers

The flame and drip resistant halogen-free insulating composition of the present invention contains at least one filler, preferably a functional filler. Examples of such filler materials are: attapulgite, bentonite, calcium carbonate, talc, clay, quartz sand, diatomaceous earth, dolomite, feldspar, silicates, silica, kaolin, mica, perlite, vermiculite, wollastonite, and combinations thereof.

The flame and drip resistant halogen-free insulating composition of the present invention has a filler content of about 10% to about 60% by weight of the total composition, and in a more particular embodiment, the filler content is about 20% to about 50% by weight.

In one embodiment of the invention, calcium carbonate is used in an amount of about 10% to about 40% by weight, and in a more particular embodiment, the calcium carbonate content is about 20% to about 35% by weight.

### Other Compounds

The flame and drip resistant halogen-free insulating composition may contain other compounds such as cross-linking agents, antioxidants, processing aids, lubricants, pigments, additives, fillers, and the like.

Suitable cross-linking agents are, for example, dicumyl peroxide (DCP); tert-butylcumyl peroxide; bis(tert-butylperoxy isopropyl)benzene; 2,5-bis (tert-butyl); 2,5-trimethylcyclohexane; 2,5-bis (tert-butylperoxy)-2,5-trimethyl cyclohexane-3; 1,1-Bis (t-butylperoxy)diisopropylbenzene, and combinations thereof. The cross-linking agents used are preferably dicumyl peroxide and 1,1-bis(t-butylperoxy)diisopropylbenzene in an amount of about 0.1 wt % to about 3% by weight, and preferably from about 1% by weight to about 2% by weight.

Suitable conventional antioxidants are, for example, polymerized trimethyldihydroquinoline; 4,4′-thiobis-(3-methyl-6-tere-butyl)phenol, pentaerythryltetra[3-(3,5-di-terebutyl-4-hydroxyphenyl)propionate]; 2,2′-thiodiethylene bis[3-(3,5-di-tere-butyl-4-hydroxyphenyl)propionate]; pentaerythritol tetrakis[3-(3,5-di-tert-butyl-4-hydroxyphenyl) propionate] and the like, or mixtures thereof. The flame and drip resistant halogen-free insulating composition of the invention has an antioxidant content of about 0.125% to about 1% by weight of the total composition.

The processing aids are, for example, calcium stearate, zinc stearate, stearate acid, paraffin wax, rubber silicon and similar, or mixtures thereof.

The lubricants used are, for example, paraffin waxes of low molecular weight, stearic acid, stearamide, oleamide, erucamide. The flame and drip resistant halogen-free insulating composition of the invention has a lubricant content of about 0.25% to about 2% by weight of the total composition.

The pigments in this type of compounds are added in concentrates of the pigmenting substance dispersed in a base polymer which has the same chemical nature as the polymer to be pigmented, i.e., to pigment polyethylene a pigment is used dispersed in polyethylene.

Other additives that can be used, are, for example, magnesium carbonate, zinc borate, trimethoxy(vynil) silane, triethoxy(vynil)silane, benzotriazoles, hindered amines.

### EMBODIMENTS OF THE INVENTION

The invention will now be described with reference to the following examples, which are only intended to represent the manner of carrying out the implementation of the principles of the invention. The following examples are not intended as an exhaustive representation of the invention, neither intended to limit the scope thereof.

To carry out the examples of the present invention, combinations of the chemical compounds shown in Table 1 were used. All these chemical compounds are commercially available and were used without any post-modification.

TABLE 1

| | COMMERCIAL | |
|---|---|---|
| CHEMICAL COMPOUND | NAME | SUPPLIER |
| Linear polyethylene grafted with maleic | Fusabon 528 | Dupont |
| anhydride (LLDPE-g-MA) | | |
| Low density polyethylene (LDPE) | PEBD 20020X | PEMEX |
| Alumina trihydrate | Micral 9400 | Huber |
| Zinc Borate | ZB2335 | Charlotte |
| | | Chemicals |
| Dicumyl Peroxide | Di-cup-R | Arkema |
| Lubricant | TR121 | Struktol |
| Phenolic antioxidant | Irganox 1010 | BASF-CIBA |

Flame and drip resistant halogen-free insulating compositions were prepared according to the invention, designated as Example 1 and Example 2, by mixing low density polyethylene with loads of alumina trihydrate, zinc borate and calcium carbonate, a compatibilizing agent grafted with maleic anhydride, as well as minor components such as lubricants, antioxidants, plus a cross-linking agent. The precise composition of Examples 1 and 2 is shown in Table 2.

After mixing the chemical compounds to make each of Examples 1 to 2, each of the compositions were extruded on separate samples of electrical conductors covered respectively in a way of a sheath forming electrical wires. These two electrical cables were tested in accordance with IEC 60032-3-22 under the following parameters:
a. Portions were prepared of electric cable length of 3.5 meters and a number of electrical cable portions were set on a tray/ladder to complete 7 liters of non-metallic material (insulating sheath according to the invention) for every meter of tray/ladder on which said cables were adjusted.
b. A flame fed by propane during 40 minutes, was applied to all portions of electrical cables.
c. To pass the test, the electrical wires exposed to the flame must show a damage less than or equal to 2.5 meters.

The effect of the leakage resistance due to the incorporation of fillers of alumina trihydrate, zinc borate and calcium carbonate, of the compatibilizing agent grafted with maleic anhydride and minor components such as lubricants, antioxidants, plus a cross-linking agent to the low density polyethylene in Examples 1 to 2, is shown in Table 2.

TABLE 2

| | Example | |
|---|---|---|
| | 1 | 2 |
| Chemical Compound | Weight % | Weight % |
| Linear low density polyethylene grafted with | 2.5 | 2.4 |
| maleic anhydride | | |
| Low density polyethylene | 50.3 | 47.8 |
| Alumina trihydrate | 15.1 | 14.4 |
| Zinc borate | 2.5 | 2.4 |
| Calcium carbonate | 25.1 | 28.7 |
| Dicumyl peroxide | 1.5 | 1.4 |
| Paraffinic lubricant | 2.0 | 1.9 |
| Phenolic antioxidant | 1.0 | 1.0 |
| TOTAL | 100 | 100 |
| Volume Resistivity (RV), Ohm-cm | 6.87 × 10¹⁵ | 6.48 × 10¹⁵ |
| Test IEC 600332-3-22 | Pass | Pass |
| Burning time after application of the flame, | Less than 8 | Less than 8 |
| minutes | | |
| Length damage (burnt), cm | Less than 61 | Less than 61 |

Based on the above described embodiments, it is observed that modifications to these embodiments described and the alternative embodiments will be considered obvious to a person skilled in the art of the art under the present description. It is therefore considered that the claims encompass said alternative embodiments, and that they are within the scope of the present invention or its equivalents.

1. A flame and drip resistant halogen-free insulating composition for an electrical cable, comprising:
from 35% to 65% by weight of low density polyethylene;
from 0.1% to 15% by weight of at least one polyolefin grafted with maleic anhydride;
from 5% to 45% by weight of at least one flame retardant; and
from 10% to 60% by weight of at least one filler; and
having a burning time less than 8 minutes after the exposure to a flame for 40 minutes, and a damage extension of less than 70 centimeters.

2. The insulating composition of claim 1, wherein said low density polyethylene has a density of 0.89 g/cm³ to 0.95 g/cm³.

3. The insulating composition of claim 1, wherein said low density polyethylene has a fluidity index of 0.1 g/min to 25 g/min.

4. The insulating composition of claim 1, wherein said composition comprises from 45% to 55% by weight of low density polyethylene.

5. The insulating composition of claim 1, wherein said composition comprises from 1% to 7% by weight of polyolefin grafted with maleic anhydride.

6. The insulating composition of claim 1, wherein said polyolefin grafted with maleic anhydride is selected from a group consisting of low density polyethylene grafted with maleic anhydride, linear low density polyethylene grafted with maleic anhydride, polypropylene grafted with maleic anhydride, high density polyethylene grafted with maleic anhydride, ethylene copolymer grafted with maleic anhydride, and combinations thereof.

7. The insulating composition of claim 1, wherein said polyolefin grafted with maleic anhydride is linear low density polyethylene grafted with maleic anhydride.

8. The insulating composition of claim 1, wherein said composition comprises from 10% to 30% by weight of flame retardant.

9. The insulating composition of claim 1, wherein said flame retardant is selected from a group consisting of synthetic alumina trihydrate, treated alumina trihydrate, natural alumina trihydrate, synthetic magnesium hydroxide, natural magnesium hydroxide, treated magnesium hydroxide, synthetic magnesium-aluminum layered double hydroxide, treated magnesium-aluminum layered double hydroxide, natural magnesium-aluminum layered double hydroxide, zinc borate, and combinations thereof.

10. The insulating composition of claim 9, wherein said flame retardant comprises alumina trihydrate and zinc borate in a rate of 1:20 to 1:5 by weight.

11. The insulating composition of claim 1, wherein said composition comprises from 20% to 50% by weight of filler.

12. The insulating composition of claim 1, wherein said filler is selected from a group consisting of attapulgite, bentonite, calcium carbonate, talc, clay, quartz sand, diatomaceous earth, dolomite, feldspar, silicates, silica, kaolin, mica, perlite, vermiculite, wollastonite, and combinations thereof.

13. The insulating composition of claim 12, wherein said filler is calcium carbonate.

14. The flame and drip resistant halogen-free insulating composition of claim 1, wherein further comprises at least one cross-linking agent selected from a group consisting of dicumyl peroxide (DCP); tert-butylcumyl peroxide; bis(tert-butylperoxy isopropyl)benzene; 2,5-bis (tert-butyl); 2,5-trimethycyclohexane; 2,5-bis (tert-butylperoxy)-2,5-trimethyl cyclohexane-3; 1,1-Bis (t-butylperoxy)diisopropylbenzene; and combinations thereof.

15. The insulating composition of claim 14, wherein said cross-linking agent is dicumyl peroxide and 1,1-bis(t-butylperoxy)diisopropylbenzene in an amount of 0.1% to 3% by weight, and preferably from 1% to 2% by weight.

16. An electrical cable comprising:
at least one electrical conductor; and
at least one flame and drip resistant halogen-free insulating sheath;
wherein said insulating sheath includes:
from 35% to 65% by weight of low density polyethylene;
from 0.1% to 15% by weight of at least one polyolefin grafted with maleic anhydride;
from 5% to 45% by weight of at least one flame retardant; and
from 10% to 60% by weight of at least one filler; and
having a burning time less than 8 minutes after the exposure to a flame for 40 minutes, and a damage extension of less than 70 centimeters.

17. The electrical cable of claim 16, wherein said low density polyethylene of said insulating sheath has a density of 0.89 g/cm³ to 0.95 g/cm³.

18. The electrical cable of claim 16, wherein said low density polyethylene of said insulating sheath has a fluid density of 0.1 g/min to 25 g/min.

19. The electrical cable of claim 16, wherein said insulating sheath comprises from 45% to 55% by weight of the low density polyethylene.

20. The electrical cable of claim 16, wherein said insulating sheath comprises from 1% to 7% by weight of polyolefin grafted with maleic anhydride.

21. The electrical cable of claim 16, wherein said polyolefin grafted with maleic anhydride of said insulating sheath is selected from a group consisting of low density polyethylene grafted with maleic anhydride, linear low density polyethylene grafted with maleic anhydride, polypropylene grafted with maleic anhydride, high density polyethylene grafted with maleic anhydride, ethylene copolymer grafted with maleic anhydride, and combinations thereof.

22. The electrical cable of claim 21, wherein said polyolefin grafted with maleic anhydride of said insulating sheath is linear low density polyethylene grafted with maleic anhydride.

23. The electrical cable of claim 16, wherein said insulating sheath comprises from 10% to 30% by weight of flame retardant.

24. The electrical cable of claim 16, wherein said flame retardant of said insulating sheath is selected from a group consisting of synthetic alumina trihydrate, treated alumina trihydrate, natural alumina trihydrate, synthetic magnesium hydroxide, natural magnesium hydroxide, treated magnesium hydroxide, synthetic magnesium-aluminum layered double hydroxide, treated magnesium-aluminum layered double hydroxide, natural magnesium-aluminum layered double hydroxide, zinc borate, and combinations thereof.

25. The electrical cable of claim 24, wherein said flame retardant of said insulating sheath is alumina trihydrate and zinc borate in a rate of 1:20 to 1:5 by weight.

26. The electrical cable of claim 16, wherein said insulating sheath comprises from 20% to 50% by weight of filler.

27. The electrical cable of claim 16, wherein said filler of said insulating sheath is selected from a group consisting of attapulgite, bentonite, calcium carbonate, talc, clay, quartz sand, diatomaceous earth, dolomite, feldspar, silicates, silica, kaolin, mica, perlite, vermiculite, wollastonite, and combinations thereof.

28. The electrical cable of claim 27, wherein said filler of said sheath is calcium carbonate.

29. The electrical cable of claim 16, wherein further said insulating sheath comprises at least one cross-linking agent selected from a group consisting of dicumyl peroxide (DCP); tert-butylcumyl peroxide; bis(tert-butylperoxy isopropyl)benzene; 2,5-bis (tert-butyl); 2,5-trimethylcyclohexane; 2,5-bis (tert-butylperoxy)-2,5-trimethyl cyclohexane-3; 1,1-Bis (t-butylperoxy)diisopropylbenzene; and combinations thereof.

30. The electrical cable of claim 29, wherein said cross-linking agent of said insulating sheath is dicumyl peroxide and 1,1-bis(t-butylperoxy)diisopropylbenzene in an amount of 0.1% to 3% by weight, and preferably from 1% to 2% by weight.
